(19) United States
(12) Patent Application Publication
(10) Pub. No.: US 2005/0237559 A1
(43) Pub. Date: Oct. 27, 2005

(54) Image printing system, image input device, and image output device

(75) Inventor: Yuichi Watanabe, (US)

Correspondence Address: TAKEUCHI & TAKEUCHI, Suite 310, 1700 Diagonal Road, Alexandria, VA, 22314, US

(73) Assignee: Oki Data Corporation

(21) Appl. No.: 11/110,739

(22) Filed: Apr. 21, 2005

(30) Foreign Application Priority Data
Apr. 26, 2004 (JP) 2004-129618

(51) Int. Cl. G06F 15/00

(52) U.S. Cl. 358/1.13

(57) ABSTRACT

An image input device includes a control language store unit for storing a plurality of control languages for controlling an image output device, and a language switching unit for selecting a specific control language from the control languages for controlling the image output device. Accordingly, it is possible to convert selected image information to image data with the specific control language compatible with the image output device connected to the image input device.

### BACKGROUND OF THE INVENTION AND RELATED ART STATEMENT

The present invention relates to an image printing system for connecting an image input device and an image output device to print an image, and also relates to the image input device and the image output device constituting the image printing system.

In a network, a plurality of printers is installed at specific locations. It is sometimes necessary to print an image with a specific one of the printers at a location where the printer is installed. Patent References 1 and 2 have disclosed image printing systems for dealing with such a situation.

In Patent Reference 1, the image printing system is formed of a scanner and a printer. The scanner is specifically designed for the printer connected to the scanner. Accordingly, the image printing system can be formed of only the specific scanner. In Patent Reference 2, it is necessary to provide a personal computer (PC) between a scanner and a printer.

Patent Reference 1; Japanese Patent Publication (Kokai) No. 2000-295399

Patent Reference 2; Japanese Patent Publication (Kokai) No. 2000-315129

As described above, in the image printing system disclosed in Patent Reference 1, the scanner can be connected only to the specific printer, thereby lacking versatility. In the image printing system disclosed in Patent Reference 2, it is necessary to provide a data processing device such as a PC between the scanner and the printer, thereby making it difficult to arrange the image printing system.

In view of the problems described above, an object of the present invention is to provide an image printing system capable of easily connecting an image input device and an image output device without a data processing device such as a PC.

Further objects and advantages of the invention will be apparent from the following description of the invention.

### SUMMARY OF THE INVENTION

In order to attain the object described above, according to the present invention, an image input device includes a control language store unit for storing a plurality of control languages for controlling an image output device, and a language switching unit for selecting a specific control language from the control languages for controlling the image output device. Accordingly, it is possible to convert selected image information to image data with the specific control language compatible with the image output device connected to the image input device.

In the present invention, the image input device can select and convert the image information to the image data with the specific control language compatible with the image output device connected thereto, thereby improving versatility. Further, it is not necessary to provide a data processing device such as a PC between the image input device and the image output device. It is easy to directly connect the image input device to the image output device through a specific connection cable.

### BRIEF DESCRIPTION OF THE DRAWINGS

FIG. 1 is a schematic block diagram showing a configuration of an image printing system according to a first embodiment of the present invention;

FIG. 2 is a schematic block diagram showing a scanner of the image printing system according to the first embodiment of the present invention;

FIG. 3 a schematic block diagram showing a printer of the image printing system according to the first embodiment of the present invention;

FIG. 4 is a flow chart showing an operational process (No. 1) of the image printing system according to the first embodiment of the present invention;

FIG. 5 is a flow chart showing the operational process (No. 2) of the image printing system according to the first embodiment of the present invention;

FIG. 6 is a schematic block diagram showing a configuration of an image printing system according to a second embodiment of the present invention;

FIG. 7 is a schematic block diagram showing a scanner of the image printing system according to the second embodiment of the present invention;

FIG. 8 a schematic block diagram showing a printer of the image printing system according to the second embodiment of the present invention;

FIG. 9 is a flow chart showing an operational process (No. 1) of the image printing system according to the second embodiment of the present invention; and

FIG. 10 is a flow chart showing the operational process (No. 2) of the image printing system according to the second embodiment of the present invention.

### DETAILED DESCRIPTION OF PREFERRED EMBODIMENTS

Hereunder, embodiments of the present invention will be explained with reference to the accompanying drawings.

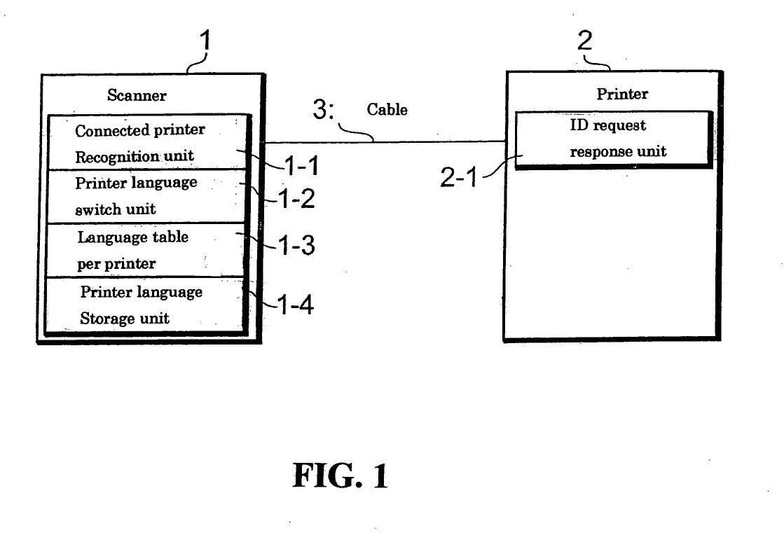

In FIG. 1, the image printing system has a scanner 1, a printer 2, and a cable 3. The scanner 1 is an image input device provided with a CCD line sensor therein for converting image information obtained from an original image to image data, and sending the image data directly to the printer 2 through the cable 3. In a typical system, a small number of the scanners are installed outside a network. When it is necessary to use one of the scanners, the scanner is moved close to one of printers installed within the network.

The printer 2 is an image output device directly connected to the scanner 1 through the cable 3 for processing the image data from the scanner 1 to print out. In a typical system, several printers are installed within a network. When it is necessary to print an original image on one of the printers, the printer is directly connected to the scanner 1 through the cable 3 to form the image printing system.

The cable 3 is a connection cable for directly connecting the scanner 1 to the printer 2, and includes a Centronics cable and a cable compatible with IEEE (Institute of Electrical and Electronic Engineers) 1394.

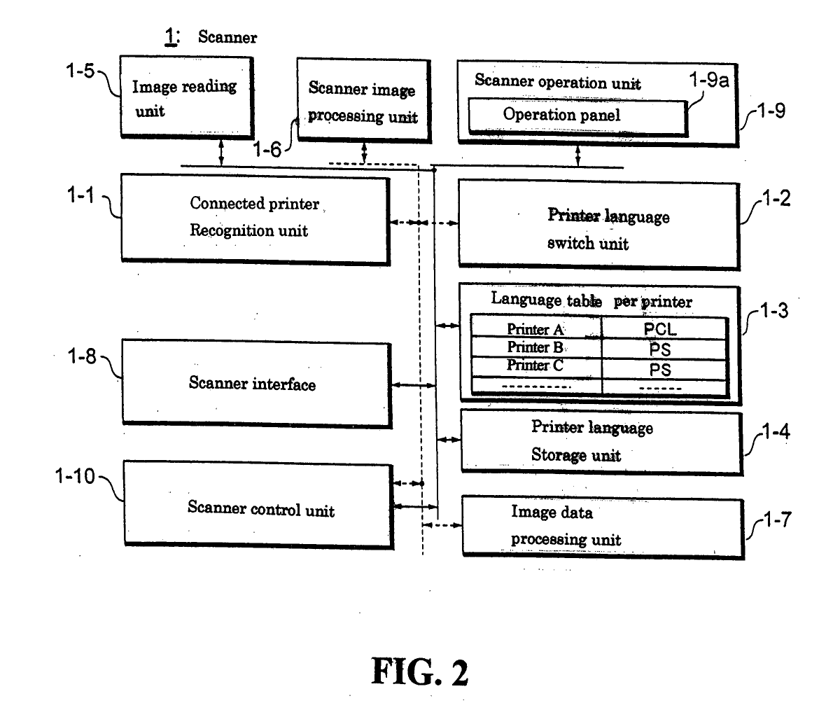

The scanner 1 and the printer 2 will be explained in detail with respect to FIG. 2. As shown in FIG. 2, the scanner 1 is provided with a connected printer recognition unit 1-1; a printer language switch unit 1-2; a language table per printer 1-3; a printer language storage unit 1-4; an image reading unit 1-5; a scanner image processing unit 1-6; an image data processing unit 1-7; a scanner interface 1-8; a scanner operation unit 1-9; and a scanner control unit 1-10.

The connected printer recognition unit 1-1 recognizes the printer 2 connected to the scanner 1 through control of the scanner control unit 1-10. When the connected printer recognition unit 1-1 recognizes that the printer 2 is connected to the scanner 1, the connected printer recognition unit 1-1 obtains an ID (identification number) of the printer 2 through a specific protocol.

The printer language switch unit 1-2 selects a control language compatible with the printer 2 from the language table per printer 1-3 through control of the scanner control unit 1-10. The printer language switch unit 1-2 also selects a control language detected from control languages stored in the printer language storage unit 1-4, and switches a control language in the scanner image processing unit 1-6.

The language table per printer 1-3 stores in advance a relationship between a printer expected to be connected to the scanner 1 and a control language compatible with the printer. As shown in FIG. 2, in the language table per printer 1-3, printers A to C correspond to control languages PCL, PS, and PS, respectively.

The printer language storage unit 1-4 is a memory for storing a control language of a printer expected to be connected to the scanner 1 in advance. That is, the printer language storage unit 1-4 stores the control languages PCL, PS, and PS in advance.

The image reading unit 1-5 obtains the image information from the original image, and includes, for example, a CCD line sensor disposed in the scanner 1. The scanner image processing unit 1-6 converts the image information obtained in the image reading unit 1-5 to the image data through control of the scanner control unit 1-10.

The image data processing unit 1-7 converts the image data to a form capable of being sent from the scanner 1 to the printer 2 (FIG. 1) with the control language switched by the printer language switch unit 1-2 through control of the scanner control unit 1-10.

The scanner interface 1-8 is an interface having a protocol for communicating a command in both directions between the scanner 1 and the printer 2 (FIG. 1). The scanner operation unit 1-9 specifies a copy mode and operates a copy process, and is provided therein with an operation panel 1-9a for displaying content and an input device (not shown) with which an operator inputs a command. The operator also uses the scanner operation unit 1-9 for inputting the language table per printer 1-3.

The scanner control unit 1-10 is a CPU (Central Processing Unit) for controlling the scanner 1 as a whole, and includes a specific memory (not shown) for storing a program operating each of the units described above. In FIG. 2, a solid line connecting among the scanner control unit 1-10; the language table per printer 1-3; the printer language storage unit 1-4, the image reading unit 1-5; the scanner interface 1-8; and the scanner operation unit 1-9 represents a signal line. A hidden line connecting among the connected printer recognition unit 1-1; the printer language switch unit 1-2; the scanner image processing unit 1-6; and the image data processing unit 1-7 represents control means of the scanner control unit 1-10 that is generated when the CPU executes the program stored in the specific memory (not shown) to operate these units.

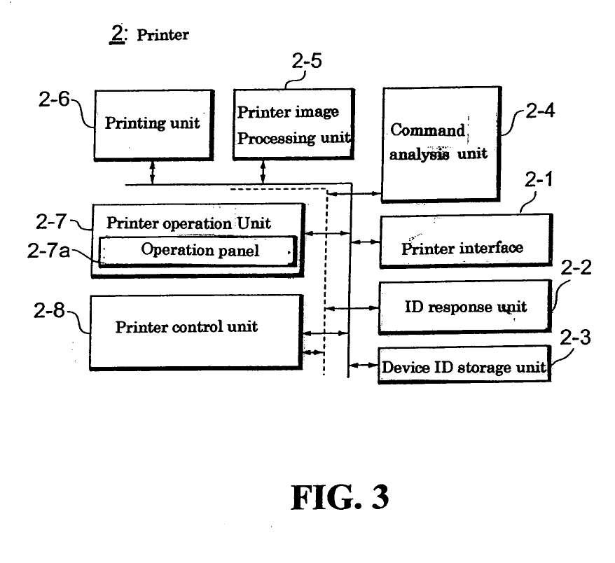

In FIG. 3, the printer 2 includes a printer interface 2-1; an ID response unit 2-2; a device ID storage unit 2-3; a command analysis unit 2-4; a printer image processing unit 2-5; a printing unit 2-6; a printer operation unit 2-7; and a printer control unit 2-8.

The printer interface 2-1 is an interface having a protocol for communicating a command in both directions between the scanner 1 (FIG. 1) and the printer 2 (FIG. 1). The ID response unit 2-2 returns a device ID of the printer when the connected printer recognition unit 1-1 (FIG. 2) requests identification of the printer.

The device ID storage unit 2-3 is a memory for storing the device ID of the printer in advance. The command analysis unit 2-4 receives and analyzes the image data processed with the control language of the printer and sent from the scanner 1 (FIG. 1) through control of the printer control unit 2-8.

The printer image processing unit 2-5 converts the image data into printable bit data through control of the printer control unit 2-8. The printing unit 2-6 is a print engine for receiving the bit data and outputting a print image. The printer operation unit 2-7 specifies a copy mode and operates a copy process, and is provided therein with an operation panel 2-7a for displaying content and an input device (not shown) with which an operator inputs a command.

The printer control unit 2-8 is a CPU (Central Control Unit) for controlling the printer 2 as a whole, and includes a specific memory (not shown) for storing a program operating each of the units described above. In FIG. 2, a solid line connecting among the printer control unit 2-8; the printer interface 2-1; the command analysis unit 2-3; the printing unit 2-6; and the printer operation unit 2-7 represents a signal line. A hidden line connecting among the printer control unit 2-8; the ID response unit 2-2; the command analysis unit 2-4; and the printer image processing unit 2-5 represents control means of the printer control unit 2-8 that is generated when the CPU executes the program stored in the specific memory (not shown) to operate the units.

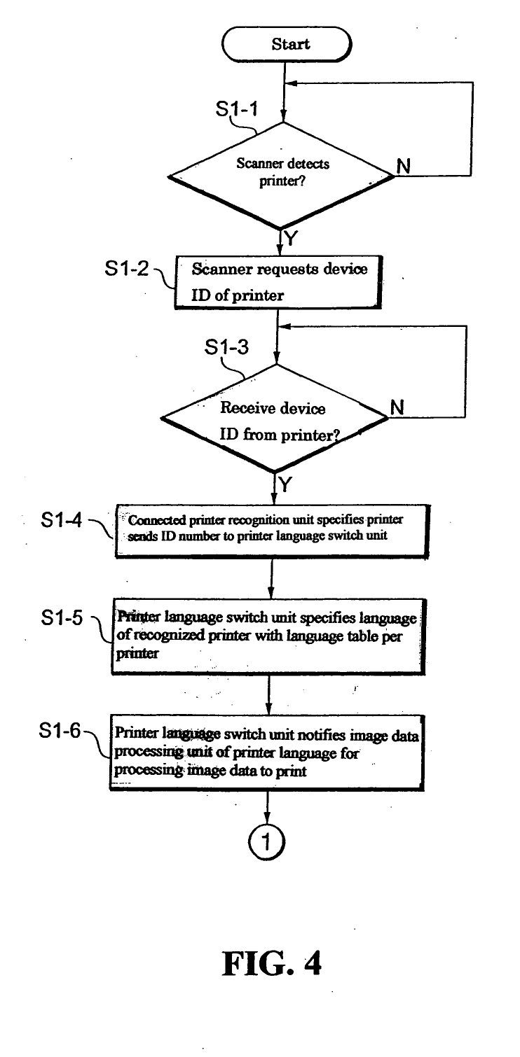

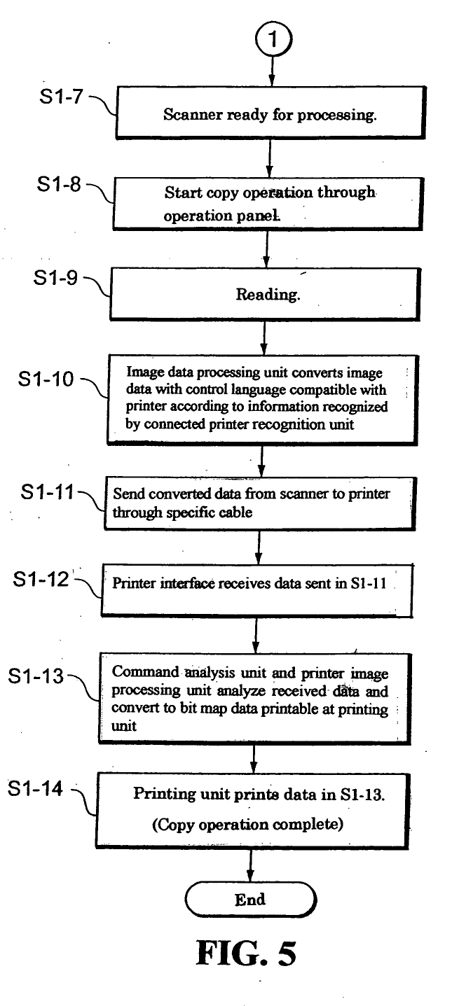

An operation of the image printing system according to the first embodiment will be explained next. FIG. 4 is a flow chart showing an operational process (No. 1) of the image printing system according to the first embodiment. FIG. 5 is a flow chart showing the operational process (No. 2) of the image printing system according to the first embodiment.

In step S1-1, the printer 2 (FIG. 1) is connected to the scanner 1 (FIG. 1) through the cable 3 (FIG. 1), so that the process flow starts. The process waits until the scanner control unit 1-10 (FIG. 2) detects that the printer 2 (FIG. 1) is connected through the scanner interface 1-8 (FIG. 2). When the scanner control unit 1-10 (FIG. 2) detects, the process proceeds to step S1-2.

In the detection, when the printer 2 (FIG. 1) is connected to the scanner 1 (FIG. 1), the printer control unit 2-8 (FIG. 3) makes the cable 3 (FIG. 1) in a state called an attach state through the printer interface unit 2-1 (FIG. 3). In the attach state, a signal cable D+of the cable 3 (FIG. 1) becomes 3.3 V. The scanner control unit 1-10 (FIG. 2) detects the attach state through the scanner interface 1-8 (FIG. 2) to detect that the printer is connected.

In step S1-2, the connected printer recognition unit 1-1 (FIG. 2) requests the printer 2 (FIG. 1) through the scanner interface 1-8 (FIG. 2) to send a reset command and a device ID. Accordingly, the ID response unit 2-2 (FIG. 3) receives the reset command through the printer interface 2-1 (FIG. 3) to reset. In this state, the ID response unit 2-2 (FIG. 3) reads the device ID from the device ID storage unit 2-3 (FIG. 3), and returns to the scanner 1 (FIG. 1) through the printer interface 2-1 (FIG. 3).

In step S1-3, the connected printer recognition unit 1-1 (FIG. 2) waits for the device ID form the printer 2 (FIG. 1). When the connected printer recognition unit 1-1 (FIG. 2) receives the device ID, the process proceeds to step S1-4.

In step S1-4, the connected printer recognition unit 1-1 (FIG. 2) sends an ID number of the connected printer 2 (FIG. 1) to the printer language switch unit 1-2 (FIG. 2). In step S1-5, the printer language switch unit 1-2 (FIG. 2) searches for the language table per printer 1-3 with the ID number to specify the control language of the connected printer 2 (FIG. 1).

In step S1-6, the printer language switch unit 1-2 (FIG. 2) sends the control language of the connected printer 2 (FIG. 1) to the image data processing unit 1-7 (FIG. 2), and requests the image data processing unit 1-7 (FIG. 2) to convert the image data with the control language.

In step S1-7, the scanner 1 (FIG. 2) is ready for processing the image information. In step S1-8, the operator inputs a specific command through the operation panel 1-9a (FIG. 2) to start the copy operation.

In step S1-9, the image reading unit 1-5 (FIG. 2) starts reading the original. In step S1-10, the image data processing unit 1-7 (FIG. 2) converts the image data to a form capable of being sent from the scanner 1 (FIG. 1) to the printer 2 (FIG. 1) with the control language compatible with the connected printer according to the information recognized by the connected printer recognition unit 1-1 (FIG. 2).

In step S1-11, the scanner interface 1-8 (FIG. 2) sends the image data converted in step S1-10 to the printer 2 (FIG. 1) through the specific cable 3 (FIG. 1). In step S1-12, the printer interface 2-1 (FIG. 3) receives the image data.

In step S1-13, the command analysis unit 2-4 (FIG. 3) and the printer image processing unit 2-5 (FIG. 3) analyze and process the image data to convert the image data into bit data printable at the printing unit 2-6 (FIG. 3). In step S1-14, the printing unit 2-6 (FIG. 3) prints the bit map data, thereby completing the process.

As described above, the scanner 1 (FIG. 1) is provided with the printer language storage unit 1-4 (FIG. 2) for storing the plurality of the control languages of the printer 2 (FIG. 1), and the printer language switch unit 1-2 (FIG. 1) for selecting a specific control language from the plurality of the control languages. Accordingly, when the printer 2 (FIG. 1) is directly connected to the scanner 1 (FIG. 1) through the cable 3 (FIG. 1), the scanner 1 (FIG. 1) can automatically recognize the control language of the printer 2 (FIG. 1), thereby improving versatility. It is not necessary to provide a data processing device such as a PC between the scanner 1 (FIG. 1) and the printer 2 (FIG. 1), thereby making it easy to connect them.

In the embodiment described above, when the printer 2 (FIG. 1) is directly connected to the scanner 1 (FIG. 1) through the cable 3 (FIG. 1), the scanner 1 (FIG. 1) can automatically recognize the control language of the printer 2 (FIG. 1). The present invention is not limited to the embodiment. Alternatively, it is possible to arrange such that the operator manually selects the control language of the printer 2 (FIG. 1) through the scanner operation unit 1-9 (FIG. 2).

In the embodiment, when the CPU executes the specific program, the control means of the scanner control unit 1-10 is generated. The control means of the scanner control unit 1-10 is formed of the connected printer recognition unit 1-1; the printer language switch unit 1-2; the command analysis unit 2-4; the scanner image processing unit 1-6; and the image data processing unit 1-7. Further, when the CPU executes the specific program, the control means of the printer control unit 2-8 is generated. The control means of the printer control unit 2-8 is formed of the ID response unit 2-2; and the printer image processing unit 2-5. The present invention is not limited to the embodiment, and a specific electric circuit can constitute all or a part of the control means.

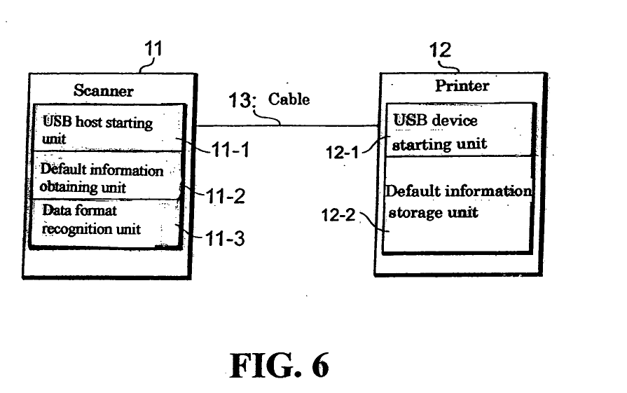

According to a second embodiment of the present invention, an image printing system uses an USB (Universal Serial Bus) cable. As shown in FIG. 6, the image printing system is provided with a scanner 11, a printer 12, and a cable 13.

The scanner 11 is an image input device provided with a CCD line sensor therein for converting image information obtained from an original image to image data, and sending the image data directly to the printer 12 through the cable 13. In a typical system, a small number (for example, one) of the scanners are installed outside a network. When it is necessary to use one of the scanners, the scanner is moved close to one of printers installed within the network.

The printer 12 is an image output device directly connected to the scanner 11 through the cable 13 for processing the image data from the scanner 11 to print out. In a typical system, several printers are installed within a network. When it is necessary to print an original image on one of the printers, the printer is directly connected to the scanner 11 through the cable 13 to form the image printing system.

The cable 13 is a connection cable for directly connecting the scanner 11 to the printer 12, and the USB (Universal Serial Bus) cable is used in the embodiment.

The scanner 11 and the printer 12 will be explained in detail only on features different from those in the first embodiment. Components same as those in the first embodiments are denoted by the same reference numerals.

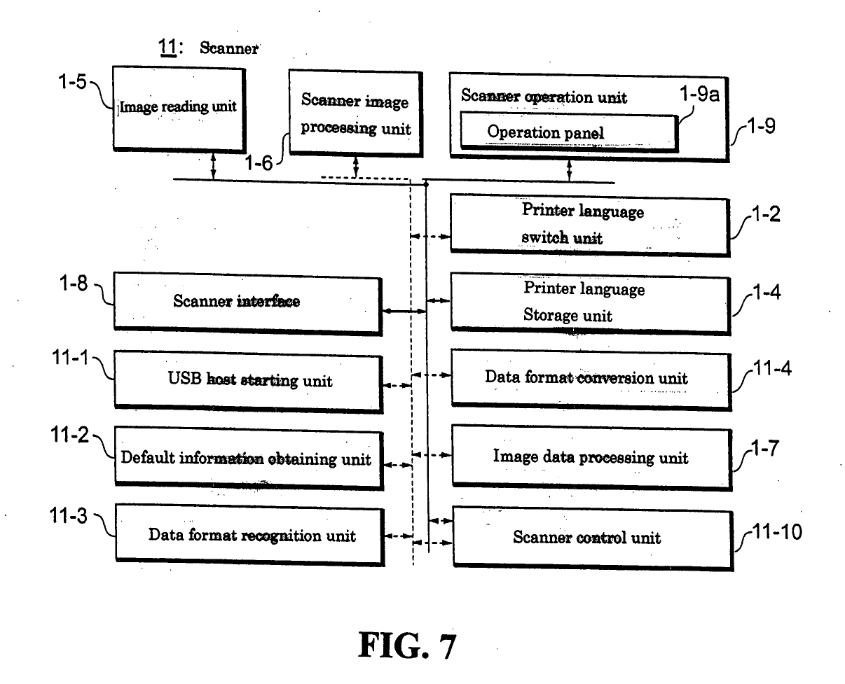

FIG. 7 is a schematic block diagram showing the scanner of the image printing system according to the second embodiment of the present invention. As shown in FIG. 7, the scanner 11 is provided with the printer language switch unit 1-2; the printer language storage unit 1-4; the image reading unit 1-5; the scanner image processing unit 1-6; an image data processing unit 1-7; the scanner interface 1-8; the scanner operation unit 1-9; a USB host starting unit 11-1; a default information obtaining unit 11-2; a data format recognition unit 11-3; a data format conversion unit 11-4; and a scanner control unit 11-10. Different from the first embodiment, the connected printer recognition unit 1-1 (FIG. 2) and the language table per printer 1-3 (FIG. 2) are omitted.

The USB host starting unit 11-1 processes a signal according to an USB protocol through control of the scanner control unit 11-10. The USB host starting unit 11-1 may be included in the scanner interface 1-8. In the embodiment, they are separated.

The default information obtaining unit 11-2 obtains default information from the printer 12 such as a control language compatible with the printer 12 and a bender identification command of the printer 12 stored in a specific memory (not shown) inside the printer 12 according to an USB protocol through control of the scanner control unit 11-10. The default information obtaining unit 11-2 specifies the control language, thereby eliminating the connected printer recognition unit 1-1 (FIG. 2) and the language table per printer 1-3 (FIG. 2).

The data format recognition unit 11-3 recognizes a data format from the coding format of the default information through control of the scanner control unit 11-10. The data format conversion unit 11-4 converts a format of image data to be sent to the printer 12 to the format recognized by the data format recognition unit 11-3 through control of the scanner control unit 11-10.

The scanner control unit 11-10 is a CPU (Central Processing Unit) for controlling the scanner 11 as a whole, and includes a specific memory (not shown) for storing a program operating each of the units described above. In FIG. 7, a solid line connecting among the scanner control unit 11-10; the printer language storage unit 1-4, the image reading unit 1-5; the scanner interface 1-8; and the scanner operation unit 1-9 represents a signal line. A hidden line connecting among the scanner control unit 11-10; the printer language switch unit 1-2; the scanner image processing unit 1-6; the image data processing unit 1-7; the USB host starting unit 11-1; the default information obtaining unit 11-2; the data format recognition unit 11-3; and the data format conversion unit 11-4 represents control means of the scanner control unit 11-10 that is generated when the CPU executes a control program stored in the specific memory (not shown) to operate these units.

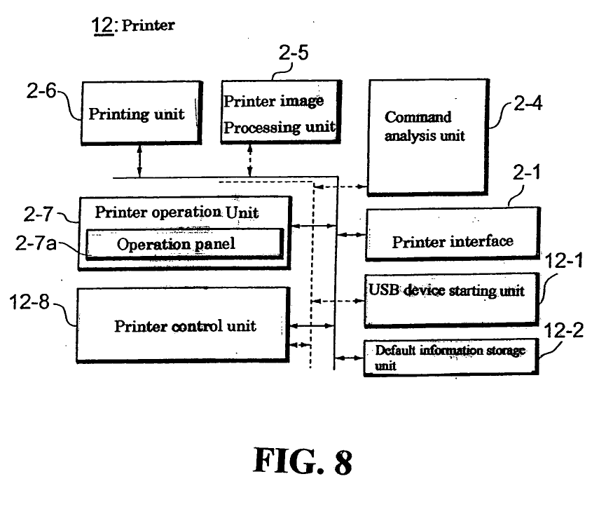

In FIG. 8, the printer 12 includes the printer interface 2-1; the command analysis unit 2-4; the printer image processing unit 2-5; the printing unit 2-6; a printer operation unit 2-7; an USB device starting unit 12-1; a default information storage unit 12-2; and a printer control unit 12-8. Different from the first embodiment, the device ID storage unit 2-3 (FIG. 3) is omitted. As explained above, in the scanner 11, it is not necessary to detect the control language compatible with the printer 12 using the device ID.

The USB device starting unit 12-1 processes a signal according to an USB protocol through control of the scanner control unit 12-8. The USB host starting unit 12-1 may be included in the scanner interface. In the embodiment, they are separated. The default information storage unit 12-2 is a memory for storing the default information of the printer 12 such as the control language and the bender identification command.

The printer control unit 12-8 is a CPU (Central Processing Unit) for controlling the scanner 11 as a whole, and includes a specific memory (not shown) for storing a program operating each of the units described above. In FIG. 8, a solid line connecting among the printer control unit 12-8; the printer interface 2-1; the printing unit 2-6; the printer operation unit 2-7; and the default information storage unit 12-2 represents a signal line. A hidden line connecting among the printer control unit 2-8; the command analysis unit 2-4; the printer image processing unit 2-5; and the USB device starting unit 12-1 represents control means of the printer control unit 12-8 that is generated when the CPU executes the control program stored in the specific memory (not shown) to operate these units.

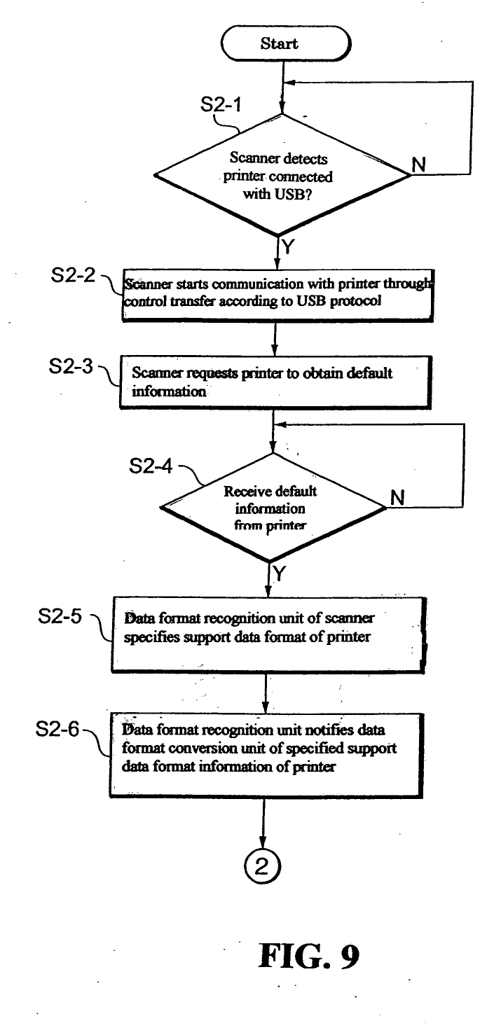

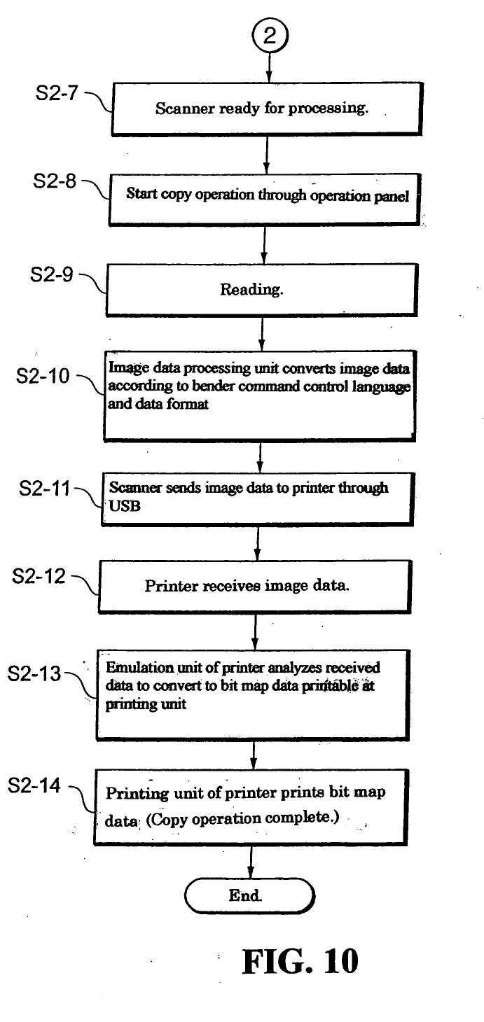

An operation of the image printing system according to the second embodiment will be explained next. FIG. 9 is a flow chart showing an operational process (No. 1) of the image printing system according to the second embodiment. FIG. 10 is a flow chart showing the operational process (No. 2) of the image printing system according to the second embodiment.

In step S2-1, the printer 12 (FIG. 6) is connected to the scanner 11 (FIG. 6) through the cable 13 (FIG. 6), so that the process flow starts. The process waits until the scanner control unit 11-10 (FIG. 7) detects that the printer 12 (FIG. 6) is connected through the scanner interface 1-8 (FIG. 7). When the scanner control unit 11-10 (FIG. 7) detects, the process proceeds to step S2-2.

In the detection, when the printer 12 (FIG. 6) is connected to the scanner 11 (FIG. 6), the printer control unit 12-8 (FIG. 7) makes the cable 13 (FIG. 6) in a state called an attach state through the printer interface unit 2-1 (FIG. 7). In the attach state, a signal cable D+of the cable 13 (FIG. 6) becomes 3.3 V. The scanner control unit 11-10 (FIG. 7) detects the attach state through the scanner interface 1-8 (FIG. 7) to detect that the printer is connected.

In step S2-2, the USB host starting unit 11-1 (FIG. 7) starts communicating with the printer 12 (FIG. 8) through the scanner interface 1-8 (FIG. 7) according to the USB protocol. The printer 12 (FIG. 8) is requested to reset. When the reset is completed after a specific period of time, communication is started through control transfer.

In step S2-3, the default information obtaining unit 11-2 (FIG. 7) requests the printer 12 (FIG. 8) to obtain the default information. At this time, the printer 12 (FIG. 8) is reset in step S2-2, and is in a default state. In this state, the USB device starting unit 12-1 (FIG. 8) reads the control language and the bender identification command from the default information storage unit 12-2 (FIG. 8), and returns them to the scanner 11 (FIG. 7).

In step S2-4, the default information obtaining unit 11-2 (FIG. 7) waits for the default information from the printer 2 (FIG. 8). When the default information obtaining unit 11-2 (FIG. 7) receives the default information, the process proceeds to step S2-5. In step S2-5, the data format recognition unit 11-3 (FIG. 7) specifies a data format compatible with the printer 12 (FIG. 8) from the default information received by the default information obtaining unit 11-2 (FIG. 7).

In step S2-6, the data format recognition unit 11-3 (FIG. 7) notifies the printer 12 (FIG. 8) of the compatible data format. The default information obtaining unit 11-2 (FIG. 7) notifies the printer language switch unit 1-2 (FIG. 7) of the control language and the bender identification command in the default information, so that the control language and the bender identification command used in the scanner 11 (FIG. 7) are specified.

In step S2-7, the scanner 11 (FIG. 7) is ready for processing the image information. In step S2-8, the operator inputs a specific command through the operation panel 1-9a (FIG. 7) to start the copy operation.

In step S2-9, the image reading unit 1-5 (FIG. 7) starts reading the original. In step S2-10, the image data processing unit 1-7 (FIG. 7) generates the image data with the control language compatible with the connected printer according to the default information received by the default information obtaining unit 11-2 (FIG. 7). Further, the image data processing unit 1-7 (FIG. 7) converts the image data to a form capable of being sent from the scanner 11 (FIG. 6) to the printer 12 (FIG. 6) through the cable 13 (FIG. 6) according to the data format recognized by the data format recognition unit 11-3 (FIG. 7).

In step S2-11, the scanner interface 1-8 (FIG. 7) sends the image data converted in step S2-10 to the printer 12 (FIG. 8) through the specific cable 13 (FIG. 6). In step S2-12, the printer interface 2-1 (FIG. 8) receives the image data.

In step S2-13, the command analysis unit 2-4 (FIG. 8) and the printer image processing unit 2-5 (FIG. 8) analyze and process the image data to convert the image data into bit data printable at the printing unit 2-6 (FIG. 8). In step S2-14, the printing unit 2-6 (FIG. 8) prints the bit map data, thereby completing the process.

As described above, in the second embodiment, the scanner 11 (FIG. 6) is provided with the USB host starting unit 11-1 (FIG. 6) for enabling start-up of the USB protocol, and the printer 12 (FIG. 6) is provided with the USB device starting unit 12-1 (FIG. 6) for enabling start-up of the USB protocol. Accordingly, it is possible to use the USB cable as the cable 13 (FIG. 6) connecting them, thereby further improving versatility in addition to the effect of the first embodiment.

In the embodiment, the control means of the scanner control unit 11-10 is formed of the printer language switch unit 1-2; the scanner image processing unit 1-6; the image data processing unit 1-7; the USB host starting unit 11-1; the default information obtaining unit 11-2; the data format recognition unit 11-3; and the data format conversion unit 11-4. The control means of the scanner control unit 11-10 is generated when the CPU executes the specific program. Further, the control means of the printer control unit 12-8 is formed of the printer image processing unit 2-5; the command analysis unit 2-4; and the USB device starting unit 12-1. The control means of the printer control unit 12-8 is generated when the CPU executes the specific program. The present invention is not limited to the embodiment, and a specific electric circuit can constitute all or a part of the control means.

In the first and second embodiments, the scanner represents the image input device, and the present invention is not limited thereto. The image input device may include a digital camera. The printer represents the image output device, and the present invention is not limited thereto. The image output device includes a fax machine or a copier.

The disclosure of Japanese Patent Application No. 2004-129618, filed on Apr. 26, 2004, is incorporated in the application.

While the invention has been explained with reference to the specific embodiments of the invention, the explanation is illustrative and the invention is limited only by the appended claims.

1. An image input device to be connected to an image output device for obtaining image information, comprising:
a control language store unit for storing a plurality of control languages for controlling the image output device,
a language switching unit for selecting a specific control language from the control languages,
an image data processing unit for converting the image information to image data according to the specific control language, and
an interface unit for sending the image data to the image output device.

2. An image input device according to claim 1, further comprising an image output device recognition unit for specifying the image output device, and a control language information storage unit for storing in advance relationship information between the image output device to be connected to the image input device and a control language compatible with the image output device.

3. An image input device according to claim 1, further comprising a set information obtaining unit for obtaining set information held in the image output device, said language switching unit selecting the specific control language according to the set information obtained by the set information obtaining unit.

4. An image input device according to claim 1, further comprising a set information obtaining unit for obtaining set information held in the image output device, and a data format recognition unit for recognizing a format of the image data compatible with the image output device according to the set information obtained by the set information obtaining unit.

5. An image input device according to claim 4, further comprising a USB host starting unit for enabling start-up of Universal Serial Bus (USB) protocol, said set information obtaining unit obtaining the set information held in the image output device according to the USB protocol.

6. An image output device to be connected to an image input device, comprising:
an identification request response unit for sending identification information of the image output device to the image input device in response to a request from the image input device,
an image processing unit for converting image data received from the image input device to print data, and
a printing unit for printing according to the printing data.

7. An image output device according to claim 6, further comprising a USB device starting unit for enabling start-up of USB protocol.

8. An image printing system comprising the image input device according to claim 1 and the image output device according to claim 6.

9. An image printing system according to claim 8, wherein said image input device is directly connected to the image output device through a connection cable.

10. An image printing system according to claim 9, wherein said connection cable includes one of a Centronics cable and a cable compatible with IEEE (Institute of Electrical and Electronic Engineers) 1394.

11. An image printing system comprising the image input device according to claim 5 and the image output device according to claim 7, said image input device being directly connected to the image output device through a USB cable.
